(19) United States
(12) Patent Application Publication
(10) Pub. No.: US 2021/0111962 A1
(43) Pub. Date: Apr. 15, 2021

(54) TOPOGRAPHICAL SEARCH

(71) Applicant: Datrium, Inc., Sunnyvale, CA (US)

(72) Inventor: Ryan Todd, Cupertino, CA (US)

(21) Appl. No.: 16/601,014

(22) Filed: Oct. 14, 2019

(51) Int. Cl. H04L 12/24; G06F 9/451; G06F 16/28; G06F 9/455

(52) U.S. Cl. CPC H04L 41/12; G06F 9/451; G06F 2009/45595; G06F 9/45558; H04L 41/22; G06F 16/288

(57) ABSTRACT

In an embodiment, a graphical map display and a graphical list display relating to nodes in a node network are instantiated and displayed as part of a graphical user interface. In an embodiment, a selection if made from the graphical list display and aspects of the graphical map display are altered. In an embodiment, a selection is made from the graphical map display and the graphical list display is altered. In an embodiment, interaction between items from the graphical list display and the graphical map display cause the manipulation of data in the nodes comprising the node network.

### TECHNICAL FIELD

The present invention relates to generating and displaying visual displays of network topology of computing and network resources in a computer-generated graphical user interface. The present invention also relates to display mechanisms for monitoring and managing data in a hybrid cloud environment.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Data systems and infrastructures are increasingly interconnected and reliant on multiple devices to function. Groups of data are increasingly stored jointly between multiple systems to meet capacity requirements and increase networking efficiency. In some cases, data is split into subsets of data which are stored on independent systems. Data may also be replicated on multiple systems for ease of access or to create a “failsafe” copy of the original data. The failsafe data can be retrieved in case of a total failure of a system storing the original data occurs.

Modern data storage solutions often require storage of massive amounts of data among multiple data storage targets, or “nodes.” As used herein, a “node” is any device/service or set of devices/services capable of storing data. Examples of nodes include, but are not limited to, a computer server, a cloud-based memory service, a personal computing device, etc. Each node has a finite storage capacity for data. Multiple nodes may be connected via a network over which the nodes can communicate and share data. Larger volumes of storable data may require larger numbers of interconnected nodes and/or higher capacity nodes to be readily accessible and propagated to failsafe copies.

As data storage needs grow and more nodes are connected to a network, it becomes increasingly difficult to track relationships between the nodes. If a particular node contains failsafe data for an original node and the original node experiences an error that renders the data stored in the original node unusable, then the particular node must be accessed as quickly as possible to mitigate the problems caused by error of the original node. Finding the particular node in a node network requires parsing a potentially massive list of nodes storing multiple instances of data. Data managers may need to manually search a list of nodes for the node which contains the sought data.

A data manager may also need to manually keep a record of the relationships between the nodes in a system in order to recall the data-sharing relationships between the nodes. For example, a data manager may need to manually record a data relationship between a failsafe node and an original node and refer to the record when the original node is subject to an error. Modern data storage solutions require that data managers minimize downtime caused by node failures to keep data readily accessible. Manipulating data nodes without a quick and reliable method of recording and viewing node relationships is a slow and inefficient process.

### BRIEF DESCRIPTION OF THE DRAWINGS

In the drawings:

FIG. 1 illustrates an example system for implementing a topographical search of data nodes according to an embodiment.

FIG. 2 illustrates an example process that may govern the implementation of a topographical search of data nodes according to an embodiment.

FIG. 3 illustrates an example general purpose computer system that may be used to implement aspects of an embodiment.

FIG. 4 illustrates an example general purpose software system that may be used to implement aspects of an embodiment.

FIG. 5A illustrates an example graphical user interface of a topographical search of data nodes according to an embodiment.

FIG. 5B illustrates an example graphical user interface of a topographical search of data nodes according to an embodiment.

FIG. 5C illustrates an example graphical user interface of a topographical search of data nodes according to an embodiment.

FIG. 5D illustrates an example graphical user interface of a topographical search of data nodes according to an embodiment.

FIG. 5E illustrates an example graphical user interface of a topographical search of data nodes according to an embodiment.

FIG. 6 illustrates an example graphical user interface of a topographical search of data nodes according to an embodiment.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are described herein that allow topographical search and parsing of data nodes in a graphical user interface to display an interactive mapping of node relationships to a data manager. A graphical user interface allows a data manager to view a visual topographical representation of a node network including visual representations of the nodes.

The topographical representation is interactive and will display and highlight particular nodes and corresponding node relationships when user interaction is detected. Selection of a node by interaction may display graphical information to a data manager including current information on a selected node as well as relationships between the selected node and other nodes within the node network.

The graphical user interface presents numerous innovative features, including: an interactive searching input bar, an interactive topographical map of a node network comprising symbols and visual connectors, and an interactive item list comprising a listing of particular relationships. Each particular relationship in the listing corresponds to a relationship of one or more nodes represented in the topographical map.

The interactive topographical map displays symbol representations of various nodes in a node network using multiple shapes, shades, words, and connecting lines to show a node's relative network relationships in the node network. A user of the graphical interface interacts with the symbol representations of the nodes and relationship lines to highlight areas of interest within the topographical map or the interactive item list. A user may also interact with the interactive item list to select a particular relationship. Selection of the particular relationship on the interactive item list highlights relevant symbols in the topographical map corresponding to nodes involved in the particular relationship. The interactive searching input bar allows a user of the graphical user interface to search various particular relationships for presentation and interaction in the interactive item list.

### Topographical Search System

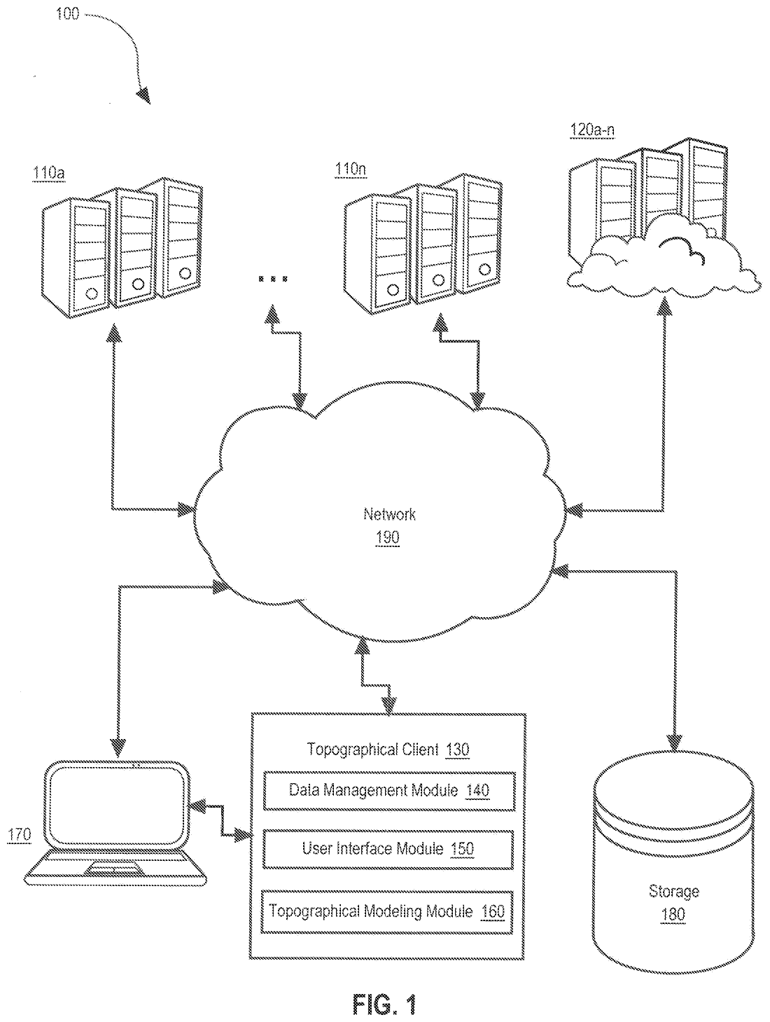

FIG. 1 illustrates an example system 100 for implementing a topographical search of data nodes according to an embodiment. Network 190 connects devices and systems 110-190. Any sufficient communication entity may operate as network 190, including a local area network, internet, intranet, and/or other type of communication mechanism, including those discussed herein. Network 190 facilitates interactions between node servers 110a-110n. Interactions may also involve a number of cloud-based node servers 120a-n. Though FIG. 1 illustrates a single cloud server, it is appreciated that any number of cloud-based node servers 120a-120n may exist connected to network 190.

Topographical client 130 is connected to network 190. Network 190 connects topographical client 130 to any of node servers 110a-110n or any number of cloud-based node servers 120a-n. Topographical client 130 may be any service, software, entity, system, or mechanism capable of configuring and displaying a topographical client as discussed herein. Operating as part of topographical client 130 and comprising elements within the client are data management module 140, user interface 150, and topographical modeling module 160.

Data management module 140 operates as part of topographical client 130 and enables the parsing, searching, manipulation and modification of data stored in any of node servers 110a-n or cloud server 120a through network 190. In various embodiments, a system implementing topographical client 130 may directly access any of node servers 110a-110n and/or cloud-based node servers 120a-n and directly add, delete, manipulate, duplicate, move, copy and/or parse data stored in memory at those nodes.

User interface module 150 operates as part of topographical client 130 and enables the display and interaction between a user and topographical client 130. The interactive searching input bar, the interactive topographical map, and the interactive item list are displayed to a user of topographical client 130 through user interface module 150. Manual user input at a system may be converted to one or more contextual interactive actions according to user interface module 150. User interface module 150 may interact with data management module 140 to manage data according to contextual interactions of a user with user interface module 150.

Topographical modeling module 160 parses data stored on node servers 110a-110n and cloud-based node server 120a-n and constructs a topographical model of the nodes in a node network. The interactive topographical map displays the topographical model generated by topographical modeling module 160 as part of a user interface generated by user interface module 150. Topographical modeling module additionally generates mapped interactions between the nodes and particular relationships between the nodes for display on the user interface.

Client device 170 is coupled to network 190 and may implement topographical client 130. Interactions between a physical user and the system 100 depicted in FIG. 1. Client device 170 comprises a digital electronic screen which displays a user interface which may be generated by user interface module 150 for interactions with topographical client 130. Storage 180 may be any additional storage coupled to network 190 and implemented for storage of data in a medium. Examples of storage 180 include a hard disk, a solid-state electronic memory, a volatile memory, a server memory, a cloud-based memory, or any other storage medium capable of storing data as part of system 100.

### Topographical Search Process

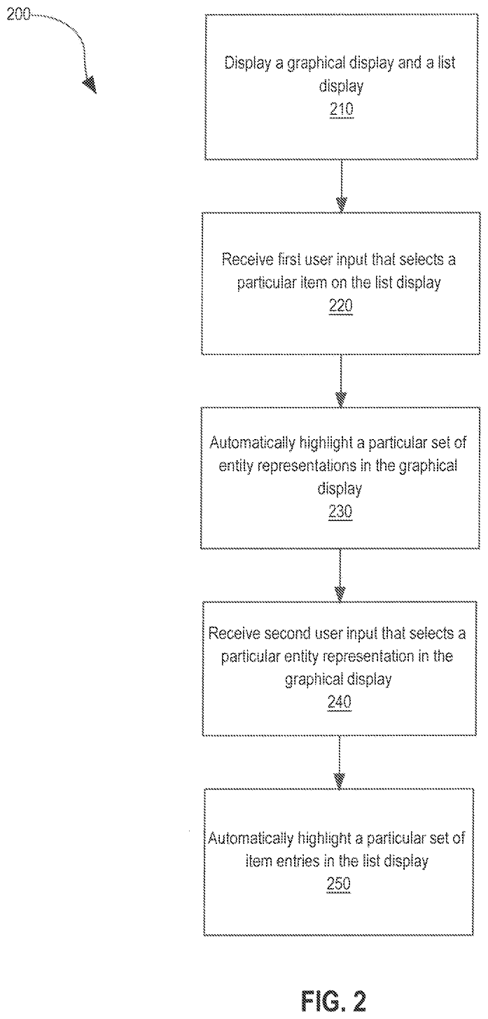

FIG. 2 illustrates an example process that may govern the implementation of a topographical search of data nodes according to an embodiment. At step 210, the process comprises displaying a graphical display and a list display. The graphical display is the interactive topographical map and the list display is the interactive item list as discussed herein. The displaying of the graphical display and the list display may be done on a device available to a user and implementing topographical client 130, such as client device 170.

In various embodiments, the graphical display and the list display are displayed next to each other in a graphical user interface. In various further embodiments, the interactive searching input bar is placed adjacent to the list display on the graphical user interface.

At step 220, the process comprises receiving first user input that selects a particular item on the list display. The first input may be an input made by a user making manual selection of an element of the particular item and facilitated through user interface module 150 of topographical client 130. The first input may be any input which interacts with the list display and may comprise a mouse click, a mouse drag, a keystroke input, touchscreen input, or any other input comprising an interaction between a user and the list display. The input may be a computer-generated input programmed to automatically select an item of the list display as part of a predetermined or periodic action.

In various embodiments, selecting a particular item on the list display comprises changing one or more aspects of the list display graphically in response to the input. For example, selection of a particular item on the list display may cause the particular item to change position on the list display, chance color, change orientation, add a border marker, and/or duplicate a graphical representation of the item.

At step 230, the process comprises automatically highlighting a particular set of entity representations in the graphical display. The automatic highlighting is performed in response to the selection of the particular item on the list display. The particular set of entity representations which are highlighted based on a determination of the relationships between the selected particular item and the corresponding set of entity representations. For example, if the particular item selected is a data backup plan for nodes in a node network, the graphical display will highlight particular nodes in the graphical display which are interconnected as part of the data backup plan.

In various embodiments, highlighting a particular set of entity representations may comprise any actions which distinguish the set of entity representations relative to other entity representations in the graphical display. Highlighting may involve moving entities, changing entity colors, adding a border graphic to entities, duplicating entities, and/or any other action which differentiates entities from other entities in the graphical display.

At step 240, the process comprises receiving second user input that selects a particular entity representation in the graphical display. The second input may be an input made by a user making manual selection of an element of the particular entity representation and facilitated through user interface module 150 of topographical client 130. The second input may be any input which interacts with the list display and may comprise a mouse click, a mouse drag, a keystroke input, touchscreen input, or any other input comprising an interaction between a user and the graphical display. The input may be a computer-generated input programmed to automatically select an item of the graphical display as part of a predetermined or periodic action.

In various embodiments, selecting a particular entity representation on the graphical display comprises changing one or more aspects of the graphical display graphically in response to the input. For example, selection of a particular entity representation on the graphical display may cause the particular entity representation to change position on the graphical display, chance color, change orientation, add a border marker, and/or duplicate a graphical representation of the item.

At step 250, the process comprises automatically highlighting a particular set of item entries in the list display. The automatic highlighting is performed in response to the selection of the particular entity representation on the graphical display. The particular set of item entries which are highlighted based on a determination of the relationships between the selected entity representation and the corresponding set of item entries. For example, if the particular entity representation selected is a data node in a node network, the list display will highlight particular items in the list display which are associated with data plans or relationships which act on that particular data node.

In various embodiments, highlighting a particular set of item entries may comprise any actions which distinguish the set of item representations relative to other item entries in the list display. Highlighting may involve moving entries, changing entry colors, adding a border graphic to entries, duplicating entries, and/or any other action which differentiates entries from other entries in the graphical display.

### Topographical Search User Interfaces

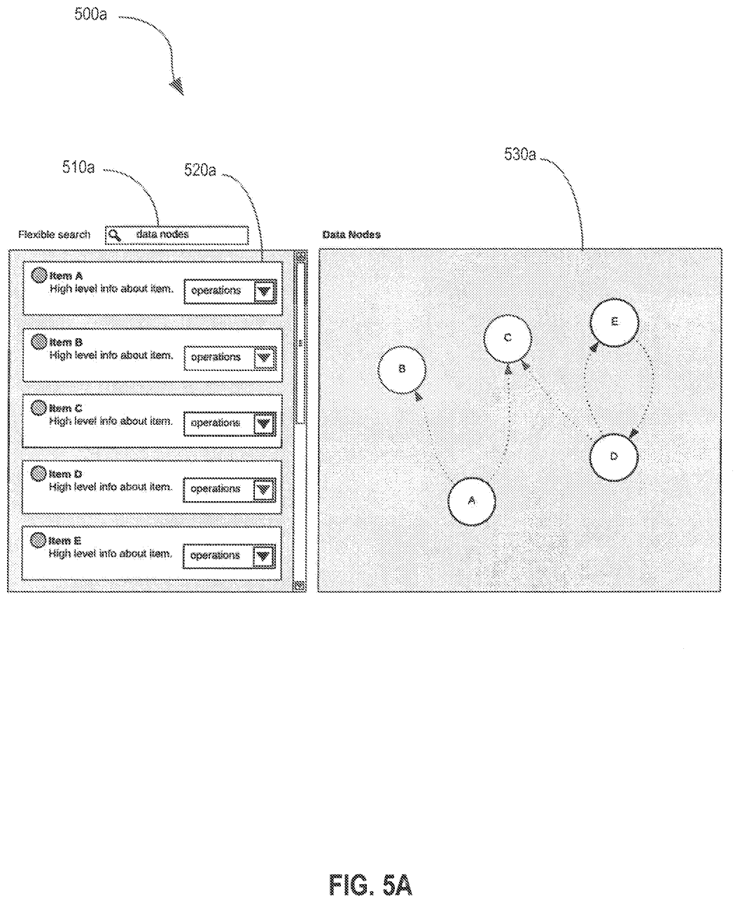

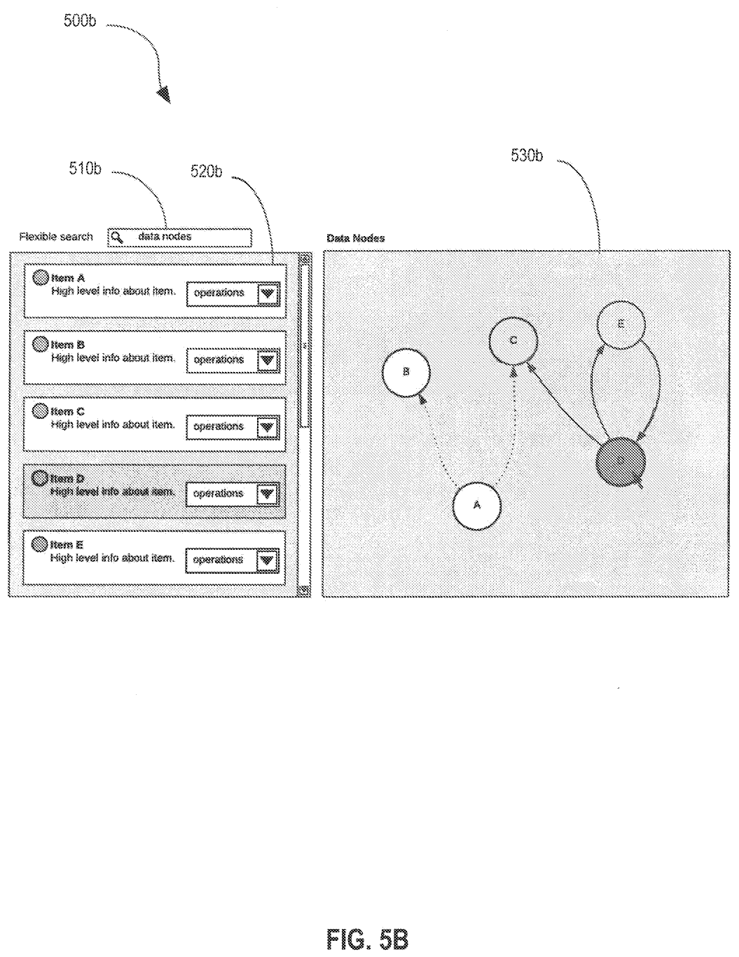

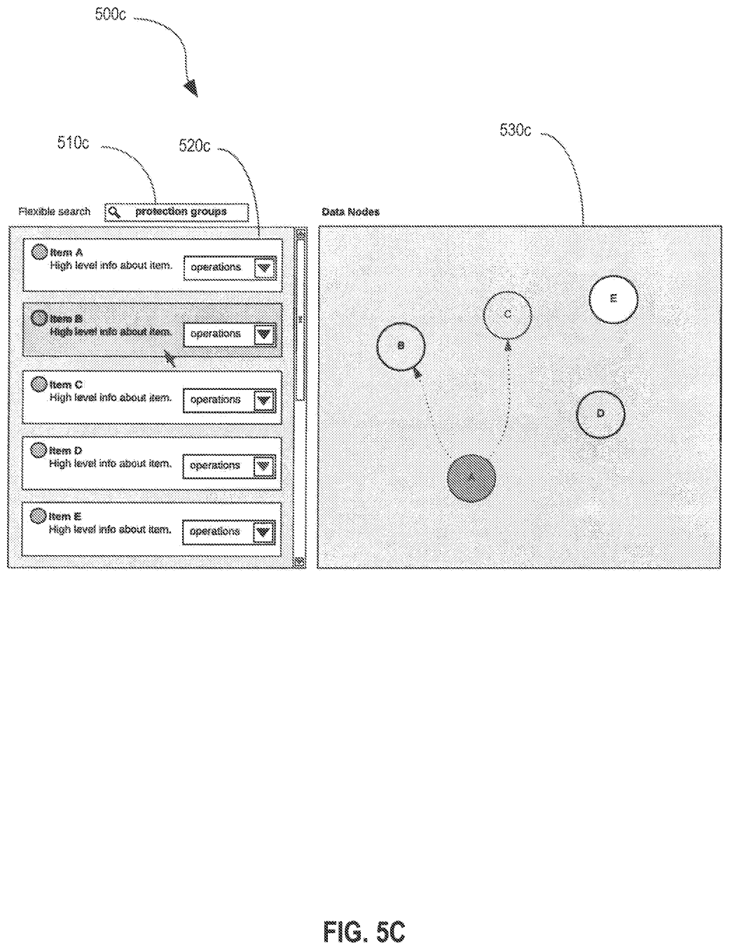

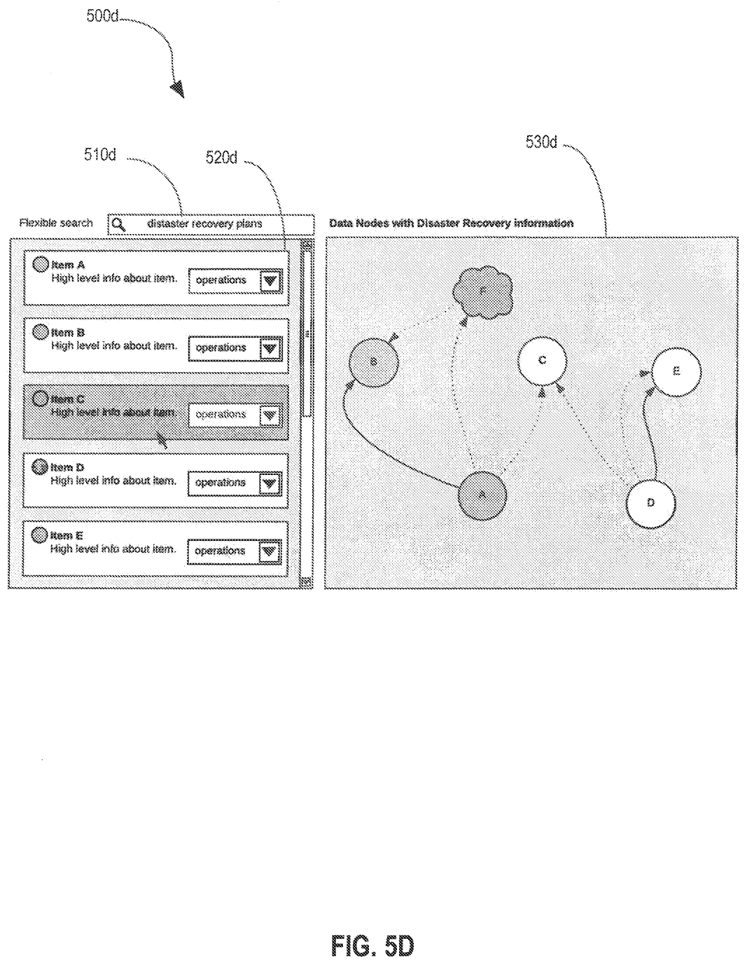

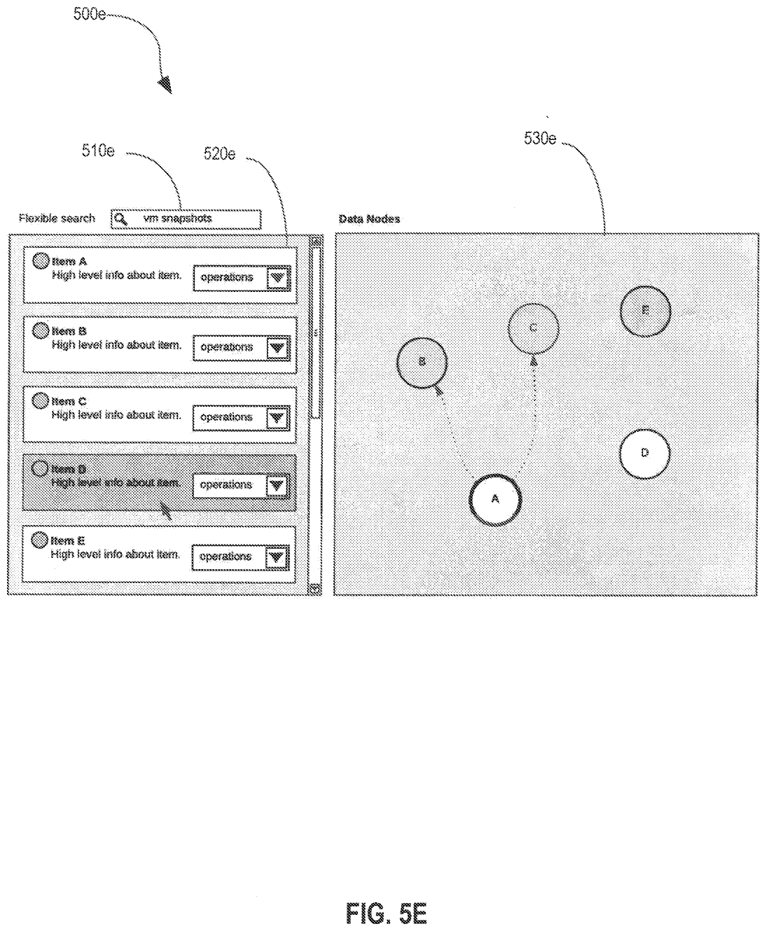

FIG. 5A illustrates an example graphical user interface 500a for presenting a topographical map of data nodes according to an embodiment. The example graphical user interface 500a is a computer-generated graphical user interface for presenting a topographical map for one or more data nodes in a node network and corresponding node relationships. The example interface of FIG. 5A comprises an interactive search field 510a, an interactive item list 520a and an interactive topographical map 530a.

The interactive search field 510a comprises an input field for a user to generate a search for items in interactive list item 520a. The user may input manual search specification data such as words via keystroke to populate interactive item list 520a with items corresponding to the search results. As depicted in FIG. 5A, a user has entered the string “data nodes” in interactive search field 510a to search for items related to data nodes in a data system.

Interactive item list 520a comprises a list view of items which are displayed as a result of input and parsing of search data in interactive search field 510a. The list view depicted in FIG. 5A shows multiple items A-E displayed as a result of the search for “data nodes” in interactive search field 510a. A scroll tab is adjacent to interactive item list 520a which may allow a user to change the display state of interactive item list 520a to display multiple items on the display.

In various embodiments, the items displayed by interactive item list 520a correspond to a set of relationships between nodes in a node network, also known as a node “plan.” A node plan is an item that stores and represents relationships between various nodes in a node network in a fashion described by the plan. For example, if a particular node stores information as a backup failsafe cache for an original node in case of failure by the original node, the particular node and the original node have a relationship. A node plan corresponding to backup failsafe instructions may show that the particular node acts as failsafe node for the original node by actively replicating data stored on the original node.

Interactive topographical map 530a comprises a map view of nodes in a node network. The nodes in the node network may be represented by various shapes, colors, symbols, characters, diagrams, lines, and/or any other visual representations sufficient to show some aspects of a node network. Interactive topographical map 530a depicts a visual representation of nodes in the node network to a user of graphical user interface 500a.

For example, as depicted in FIG. 5A, a node network comprises nodes A, B, C, D, and E, representing individual server memories for storing data such as node servers 110a-110n. Each of nodes A-E is represented by a circular symbol with a character symbol indicating the node's designation in the node network. In various embodiments, the placement of nodes in the interactive topographical map 530a represents a real-world arrangement of node servers according to physical geography. In various embodiments, the placement of nodes in the interactive topographical map 530a is dependent on an arrangement of nodes on the interactive topographical map 530a to minimize confusion and allocate efficient screen space to the display.

Interactive topographical map 530a as depicted in FIG. 5A depicts various lines running between nodes, also known as “edges.” For example, interactive topographical map 530a shows a dotted line edge running between node A and node B with a leading arrow pointed to node B. The dotted line edge between node A and node B represents a relationship between node A and node B, such as a data backup failsafe as described above. In various embodiments, two or more nodes may be interrelated, such as nodes D and E as depicted in FIG. 5A. As seen on the interactive topographical map 530a, node D and node E each have a dotted line edge with a leading arrow pointing to each other, representing a bi-directional relationship between nodes D and E.

In various embodiments, the interactive topographical map 530a uses different colors, sizes, node accents (e.g., line width or pattern), and edge treatments (e.g., animation, line width, color, arrows) to provide rich visual information that allows for at-a-glance identification of relationships, issues with the entities, focus, and/or selection of the nodes, which relates directly to the items represented in interactive item list 520a. For example, each node may be represented as an entity in a different color such that a node can be easily identified and distinguished from other entities in the graphical user interface. Different categories or color coding may be used depending on the interface configuration. In some embodiments, an entity displayed on interactive topographical map 530a can be a representation of a virtual machine that runs on a node server, such as node servers 110a-110n.

FIG. 5B illustrates an example graphical user interface for presenting a topographical map of data nodes according to an embodiment. Specifically, FIG. 5B depicts an example graphical user interface 500b similar to example graphical user interface 500a subsequent to the performance of user input on interface 500a. Interactive search field 510b is similar to interactive search field 510a and represents the input of the string of characters “data nodes” in the interactive search field. Interactive item list 520b displays similar results to interactive item list 520a, except the plan item “Item D” has been highlighted according to user input made to interactive topographical map 530b.

As depicted in interactive topographical map 530b, a node network similar to interactive topographical map 530a is depicted, but the map has been altered according to user input. Specifically, user input by a mouse cursor has selected node D in the node network via a mouse click input. As a result, node D has been highlighted in a larger color and with a larger border line to depict the selection of node D. As a result of the selection of node D, nodes C and E have been altered to comprise a darker color. Edge lines between nodes C, D, and E, are represented by straight lines with leading arrows. As a result of selection of node D, a corresponding list relationship, namely “Item D” on interactive item list 520b, has been highlighted by shading the Item D box with a darker color. In this example interface, item D refers to all information relating to the entity representing node D in interactive topographical map 530b.

In various embodiments, selecting a node or entity from interactive topographical map 530b will automatically cause altering of the example graphical user interface 500b to show relationships inherent to node D. For example, selection of node D designates node D as the highlighted node. The highlighted node in the interactive topographical map 530b will be displayed with a different level of shading than other non-highlighted nodes. Node which directly interact or are connected with the highlighted node may be displayed with a different level of shading than non-highlighted nodes. Additionally, edge lines may be darkened to show the direct connection relationship between the highlighted node and the connected node.

This configuration is depicted in interactive topographical map 530b in which node D has been selected as the highlighted node. Node D has been darkened in interactive topographical map 530b with a particular shading and connected nodes C and E have been darkened with a slightly lighter shading than node D to show a connected relationship between the nodes. Solid edge lines with leading arrows show the connections between the nodes, namely that node D is connected to nodes C and E and node E is connected to node E. In various embodiments, connection of a node may represent the ability to send or alter information on a node in a one-way fashion. For example, node D as depicted in interactive topographical map 530b may alter in or send information to node C for storage as indicated by the solid edge line with leading arrow pointing to node C. However, node C may not alter information in or send information back to node D due to the lack of a solid edge line with leading arrow connected to node D from node C.

In various embodiments, interactive topographical map 530b may alter the display of certain entities in interactive topographical map 530b that are not highlighted. For example, in response to selecting a node in interactive topographical map 530b, one or more entities or representations in interactive topographical map 530b may be omitted from the display. As depicted in FIG. 5B, nodes A and B have no relationship to node D. In an embodiment, upon the selection of node D, entities representing nodes A and B and any edges relating to nodes A and B in interactive topographical map 530b may be hidden from the node network representation for purposes of clarity and efficiency. In various embodiments, selecting or highlighting a node in the node network may cause other nodes or edges not in the network to be shaded a less conspicuous color or may cause selected and related nodes and edges to be shaded in a more conspicuous color.

In various embodiments, selecting a node representation in interactive topographical map 530b or interactive item list 520b may show details about the selected and highlighted nodes. For example, if node D is a node representing a node server such as node server 110a, selecting node D in interactive topographical map 530b may instantiate another graphical display comprising information related to the node server 110a. Examples of information may be, but are not limited to, server name, server location, number of hosts accessing the server, a number of active virtual machines hosted on the server, the health of the server, a number of data notes which are hosted at a physical server, and/or the storage capacity and use of the server memory.

In various embodiments, a user may interact with an item from interactive item list 520b by using mouse input to drag an item from the interactive item list 520b to another portion of example graphical user interface 500b. Ending the drag interaction while overlapping another item in the example graphical user interface 500b with a mouse cursor may cause some additional action to be taken. For example, dragging an item from interactive item list 520b to a node in interactive topographical map 530b may cause some action to occur between the item and the node, such as replication of the information. As an example, if a user were to drag “Item B” from the interactive item list 520b to node A in the interactive topographical map 530b, the information inherent to Item B may be replicated on node A and specifically stored on a node server corresponding to node A.

Another action may be the creation of a backup failsafe plan, or “disaster recovery plan” as discussed herein. For example, if Item B were dragged to node A, an option to apportion a section of memory on the node server corresponding to node A may be presented. If a user accepts to option to apportion the memory, a section of memory on the node server corresponding to node A will be overwritten with data from the node server representing item B. Another action may be the comparison between nodes. For example, if Item B were dragged to node A, a graphical interface may be instantiated which depicts information differences between nodes A and B. Examples of compared information may be those discussed above, such as storage capacity, number of data nodes, number of virtual machines running, etc.

In various embodiments, an item in the interactive item list 520b and an entity in the node network depicted in interactive topographical map 530b relate to a disaggregated Hyperconverged Infrastructure (HCI) solution entity. An example of an HCI is DVX, commercially available from DATRIUM INC. An HCI entity as used herein refers to a network entity used in a HCI as part of a representative networking solution. Interaction with the interactive item list 520b may further comprise retrieving additional information related to the HCI item. For example, clicking on, or interacting with a drop-down menu on an item may show various levels of information about that item, including a number of virtual machines, currently operating on the HCI, a number of protection groups available to the HCI, a number of disaster recovery plans available for the HCI, or any other information pertinent to the operation of a HCI item. Interaction with the corresponding entity representing a node in the interactive topographical map 530b may display and allow access to similar information.

In various embodiments, selecting items from the interactive item list 520b or the interactive topographical map 530b may allow the option for a user to access a web-based interface for a specific node or entity represented thereon. In various further embodiments, a hyperlink is presented to a user which will access the web interface in response to the interaction with the item or entity.

FIG. 5C illustrates an example graphical user interface for presenting a topographical map of data nodes according to an embodiment. Specifically, FIG. 5C depicts an example graphical user interface 500c similar to example graphical user interfaces 500b or 500a subsequent to the performance of user input on interactive item list 520c. Interactive search field 510c is similar to interactive search fields 510b and 510a and represents the input of the string of characters “protection groups” in the interactive search field. Accordingly, interactive item list 520c displays Items A-E which are protection group data for nodes in a node network. Interactive topographical map 530c displays the nodes in the node network.

Protection groups refers to a process in which a source node contains data in the corresponding node server. The source node is the main point of access for that data by users over a network. Various destination nodes store similar data to the source node in case a failure occurs at the source node and the data is accessed. Destination nodes correspond to node servers which contain data that is actively replicated to synchronize with the source node. In the event of a failure at the source node, any data lost by the source node may be copied from the destination nodes. Destination nodes which are not being actively replicated but contain data from the source node are orphan nodes.

As depicted in FIG. 5C, the protection group data titled “Item B” has been selected by a user and has been highlighted by corresponding shading in the interactive item list 520c. Interactive topographical map 530c has been altered to show specific relationships between nodes corresponding to the data contained in Item B. For example, Item B relates to a protection group where node A is the source node, as indicated by darker shading. Both of nodes B and C are destination nodes as indicated by lighter shading and a dotted edge line with leading arrows. The dotted edge lines represent active data replication being performed on the nodes. Node D is an orphan node depicted by the lighter shading indicating a storage relationship with node A. No dotted edge lines run to node D from node A, meaning node D is not being actively replicated upon and it therefore an orphan node.

As discussed above, various entities or edges may be omitted from the interactive topographical map 530c when a select item does not bear any relationships to the entities. For example, no edges are presented between entities other than node A. Because the protection plan of Item B only relates to which nodes are replicating data from source node A, any other information is extraneous and may be omitted from the interactive topographical map 530c for clarity. In various embodiments, after selecting an item from interactive item list 520c, a user may interact with a node in the interactive topographical map 530c, such as node A. Selection of node A may further comprise information about source node A relating to the protection group. This information may relate to the name of the node, the contents of what is stored on the node, the health of the node, whether a schedule for replicating the node is active, and/or another other information which may be relevant to the function of the node. In various embodiments, information may include the number of data snapshots comprising the node. A data snapshot is a collection of stored data on the source node which is to be actively replicated to the various destination nodes.

In various embodiments, the destination nodes store some subset of the data snapshots of the source node in internal memory. In various further embodiments, data snapshots are spread among the various destination nodes in different proportions or orders. When a recovery operation is requested at the source node following a loss of data, the source node may retain any snapshots where were not damaged by the failure and copy missing snapshots from the destination nodes as needed to become whole.

In various embodiments, interacting with an item from the protection group list or the corresponding nodes in the node network on example graphical user interface 500c may cause one or more actions to occur. For example, dragging a protection group item from the interactive item list 520c to a node may cause replication of snapshots specified by the protection group to that node. In some instances, a one-time replication of snapshots may be copied to a node, potentially creating an orphan node. Selection of the protection group item may further allow a user to access information related to the item from a graphical display or drop-down menu, such as the option to create a new set of snapshots, the view of all snapshots in a protection group item, all virtual machines hosting and operating the snapshots, or a live topography of all stored snapshots and their locations.

Selection of a node in the node network subsequent to selecting a protection group on interactive topographical map 530c may further cause a display which presents filtering, on the interactive item list, of a group of items corresponding to protections groups having data snapshots stored on that node. Selection of a node may further cause a user to view snapshot protection groups which reside on a node which is a HCI or virtual machines that are live or are stored in snapshot form on the HCI. In various embodiments, interacting with a node which is not a source, destination, or orphan node may allow a user to set the node to be a destination or orphan node as part of a protection group item.

FIG. 5D illustrates an example graphical user interface for presenting a topographical map of data nodes according to an embodiment. Specifically, FIG. 5D depicts an example graphical user interface 500d similar to example graphical user interfaces discussed subsequent to the performance of user input on interactive item list 520d. Interactive search field 510d is similar to interactive search fields discussed above and represents the input of the string of characters “disaster recovery plans” in the interactive search field. Accordingly, interactive item list 520d displays Items A-E which are disaster recovery plan data for nodes in a node network. Interactive topographical map 530d displays the nodes in the node network.

A disaster recovery plan refers to a process wherein a failure at a source node will prompt a destination node to undertake the active operations of the source node. Archive nodes and other destination nodes storing information and snapshots needed to run the active operations are send to the undertaking destination node. As such, the undertaking destination node can continue to allow access and operations to the node network while the failure of the source node is corrected.

As depicted in FIG. 5D, the disaster recovery plan data titled “Item C” has been selected by a user and has been highlighted by corresponding shading in the interactive item list 520d. Interactive topographical map 530d has been altered to show specific relationships between nodes corresponding to the data contained in Item C. For example, Item C relates to a disaster recovery plan where node A is the source node, as indicated by darker shading. Nodes B is a destination node that will undertake operations following node A's failure, as indicated by darker shading. In various embodiments, an undertaking and source node are different colors or shapes to differentiate their operations on the interactive topographical map 530d. In various embodiments, selection of a disaster recovery plan in interactive item list 520d may cause some nodes in the node network depicted by interactive topographical map 530d change shape or color to differentiate the source and destination nodes. A solid edge line with a leading arrow connects node A to node B to indicate that node B will undertake operations upon the failure of node A. Node F is a destination node, referred to as an archive site in the context of disaster recovery, and is connected to destination node B to send information to node B in case of a failure at node A. A cloud icon represents node F to show that node F is different than other nodes in the node network and may send and store data in a form different than other nodes. Node F may be a cloud-based node server such as one of cloud-based node servers 120a-n.

The plan of Item C indicates that node B will undertake operations instead of node A in the case of failure of node A, using information supplied from node F. In various embodiments, operations undertake may include operation of a HCI system, operation of one or more virtual machines, supply and intake of data from another system or node, or any other operation capable of being performed by a node. As discussed above, various entities or edges may be omitted from the interactive topographical map 530c when a select item does not bear any relationships to the entities. For example, though the disaster recovery plan specified that node B will undertake operations using data partially supplied from node F, no interaction is made between nodes B and C. As a result the dotted edge line running between node A and node C may not be consequential to the disaster recovery plan, and may be omitted if desired. In various embodiments, omission of entities in the interactive topographical map 530d or any other interactive topographical map may be specified by a user as part of user-controlled settings or a control panel built into any user interface.

In various embodiments, after selecting an item from interactive item list 520d, a user may interact with a node in the interactive topographical map 530d, such as node A. Selection of node A subsequent to selection of item C may further comprise information about source node A relating to the disaster recovery plan specified in item C. This information may relate to the name of the node, the status of the latest fail-over undertaking, the number of protection groups associated with a disaster recovery plan using the node as a source, an indicator of the results of a compliance check, and/or another other information which may be relevant to the function of the node.

In various embodiments, interacting with an item from the disaster recovery plan list or the corresponding nodes in the node network on example graphical user interface 500d may cause one or more actions to occur. Selection of a disaster recovery plan item may further allow a user to access information related to the item from a graphical display or drop-down menu, such as the option to enable or disable a plan, edit a plan, executed a planned failure, execute an unplanned failure, or test a failure. Selection of a node in the node network subsequent to selecting a protection group on interactive topographical map 530d may further cause a display which presents further information about the plan, including the filtering of plans which involve the particular node as a HCI node, or the viewing of protection groups involving the node as a HCI node.

FIG. 5E illustrates an example graphical user interface for presenting a topographical map of data nodes according to an embodiment. Specifically, FIG. 5E depicts an example graphical user interface 500e similar to example graphical user interfaces discussed subsequent to the performance of user input on interactive item list 520e. Interactive search field 510e is similar to interactive search fields discussed above and represents the input of the string of characters “vm snapshots” in the interactive search field. The term “vm snapshots” refers to a virtual machine snapshot, and more specifically to data which stores instances of a virtual machine in memory. Accordingly, interactive item list 520e displays Items A-E which represent virtual machine snapshot data for nodes in a node network. Interactive topographical map 530e displays the nodes in the node network.

A virtual machine snapshot item refers to a relationship between nodes in which a source node contains the primary implementation of a virtual machine and several destination nodes contain copies of the implementation of the virtual machine. As depicted in FIG. 5E, the virtual machine snapshot data titled “Item D” has been selected by a user and has been highlighted by corresponding shading in the interactive item list 520e. Interactive topographical map 530e has been altered to show specific relationships between nodes corresponding to the data contained in Item D. For example, Item D relates to a virtual machine snapshot relationship where node A is the source node, as indicated by darker shading around the perimeter of the node.

Nodes B and C are destination node storing copies of the virtual machine in memory, as indicated by the darker shading of the circles. The dotted edge line with leading arrow represents an active replication existing from node A to nodes B and C of the snapshots of the virtual machine(s). In the event that a virtual machine is not accessible at node A or an additional implementation of the virtual machine is needed, nodes B and C may use the copies of the implementations to instantiate the virtual machines. Interaction with the interactive item list 520e may allow a user to view additional information related to the virtual machine snapshot, such as the name of the virtual machine, the last time the virtual machine was accessed, the number of virtual machines included in the snapshot, the total file size of the virtual machines, the side of each virtual machine, and the expiration date of the virtual machine implementations which are active.

Interaction with an item on the interactive item list 520e may further allow a user to clone a snapshot, delete or restore a snapshot, or view the snapshots relationships on the interactive topographical display 530e. In various embodiments, dragging an item to a node in the interactive topographical display 530e may cause the replication of the snapshot to a HCI node, the cloning of a snapshot existing in a HCI node, or the restoration of a snapshot in a HCI node. Interaction with the nodes in interactive topographical display 530e may allow a user to filter snapshot lists on the interactive item list 520e according to snapshot which are included in the node, as well as view snapshots which are part of protection groups in the node.

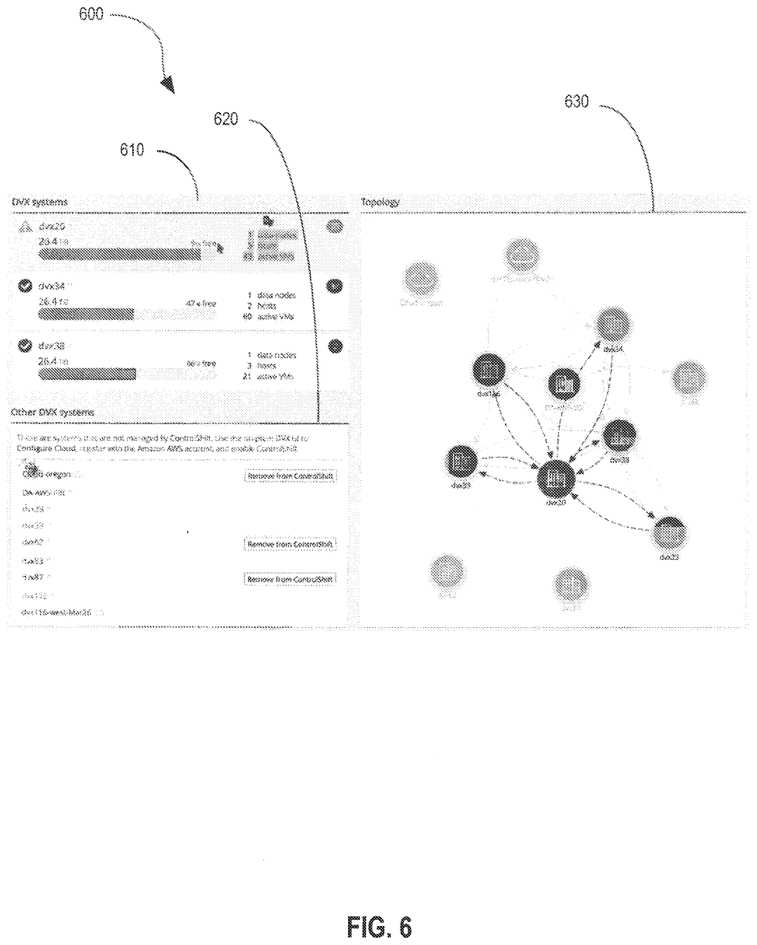

FIG. 6 illustrates an example graphical user interface for presenting a topographical map of data nodes according to an embodiment. Specifically, FIG. 6 depicts a graphical user environment in which the above embodiments can be implemented. User interface 600 comprises an environment including HCI systems list 610, HCI subsystems list 620 and Topology map 630. DVS systems list 610 may be a list which displays the names and information of various HCI nodes in a node network. In various embodiments, HCI systems list 610 displays only nodes which are accessible and subject to manipulability by a user implementing a topographical client, such as topographical client 130.

In various further embodiments, HCI subsystems list 620 may list nodes which are part of the node network and interact with HCI nodes, but are not accessible and subject to manipulability by a user. Topology map 630 may display information related to a user selection from either of the lists. For example, as depicted in FIG. 6, topology map 630 has been edited to highlight the interactions of HCI node “dvx20” subsequent to the selection of that node by a user in the HCI systems list 610. In various embodiments, selecting a node like dvx20 node directly from the topology map 630 may cause highlighting of the list entry for dvx20 on the HCI systems list 610. In various embodiments, the search and selection processes and example interfaces presented in FIGS. 5A-5E may be implemented as part of user interface 600.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

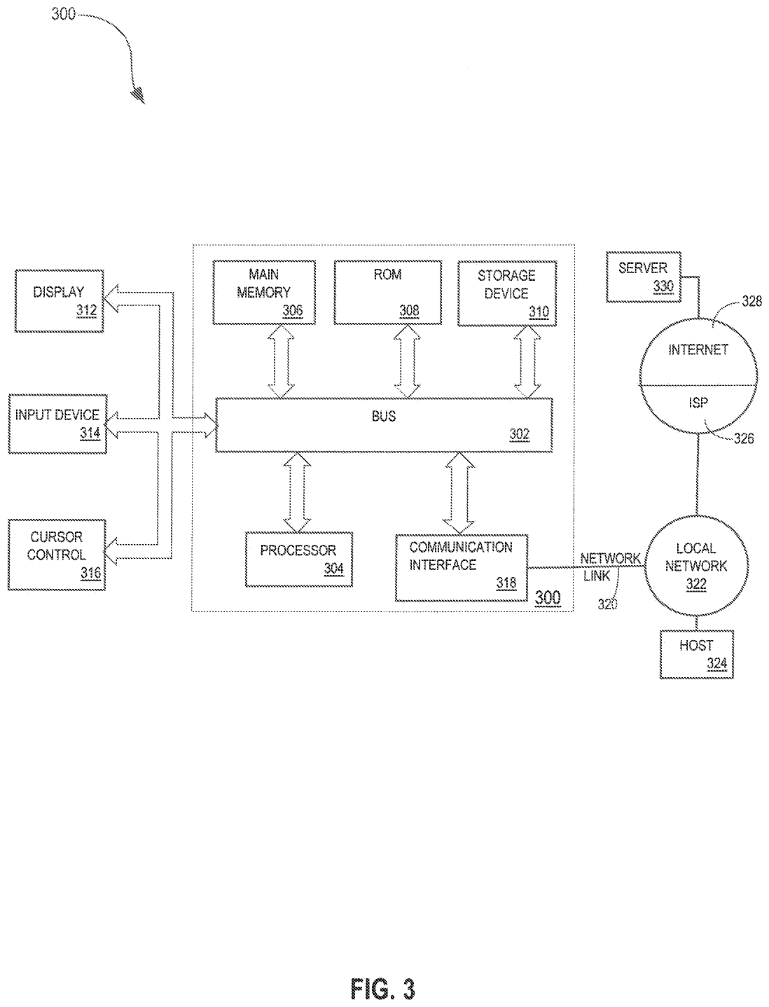

For example, FIG. 3 is a block diagram that illustrates a computer system 300 upon which an embodiment may be implemented. Computer system 300 includes a bus 302 or other communication mechanism for communicating information, and a hardware processor 304 coupled with bus 302 for processing information. Hardware processor 304 may be, for example, a general-purpose microprocessor.

Computer system 300 also includes a main memory 306, such as a random-access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Non-volatile media may also include persistent memory, such as MRAM or PCM, like 3DXPoint from Intel which can be used as a part of main memory. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the worldwide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 930 might transmit a requested code for an application program through Internet 328, ISP 326, local network 322 and communication interface 318.

The received code may be executed by processor 304 as it is received, and/or stored in storage device 310, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### Software Overview

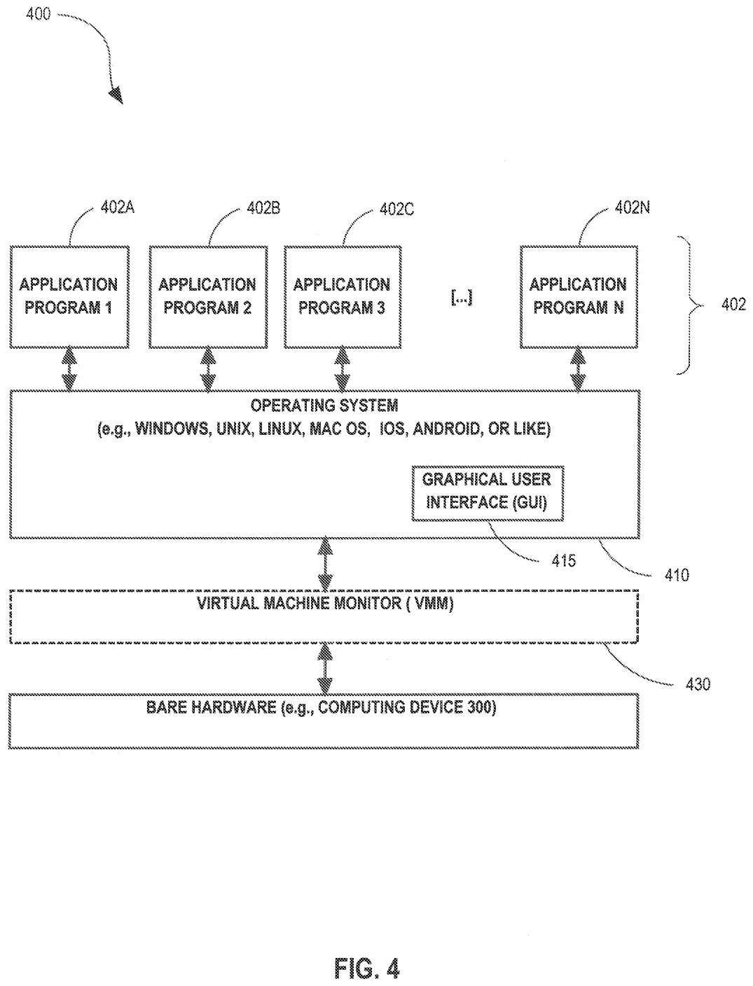

FIG. 4 is a block diagram of a software system 400 that may be employed for controlling the operation of computer system 400. Software system 400 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 400 is provided for directing the operation of computer system 500. Software system 400, which may be stored in system memory (RAM) and on fixed storage (e.g., hard disk or flash memory) 310, includes a kernel or operating system (OS) 410.

The OS 410 manages low-level aspects of computer operation, including managing execution of processes, memory allocation, file input and output (I/O), and device I/O. One or more application programs, represented as 402A, 402B, 402C . . . 402N, may be “loaded” (e.g., transferred from fixed storage into memory) for execution by the system. The applications or other software intended for use on system may also be stored as a set of downloadable computer-executable instructions, for example, for downloading and installation from an Internet location (e.g., a Web server, an app store, or other online service).

Software system 400 includes a graphical user interface (GUI) 415, for receiving user commands and data in a graphical (e.g., “point-and-click” or “touch gesture”) fashion. These inputs, in turn, may be acted upon by the system 300 in accordance with instructions from operating system 410 and/or application(s) 402. The GUI 415 also serves to display the results of operation from the OS 410 and application(s) 402, whereupon the user may supply additional inputs or terminate the session (e.g., log off).

OS 410 can execute directly on bare hardware (e.g., processor(s)) utilizing system 400. Alternatively, a hypervisor or virtual machine monitor (VMM) 430 may be interposed between the bare hardware and the OS 410. In this configuration, VMM 430 acts as a software “cushion” or virtualization layer between the OS 410 and the bare hardware of the system.

VMM 430 instantiates and runs one or more virtual machine instances (“guest machines”). Each guest machine comprises a “guest” operating system, such as OS 410, and one or more applications, such as application(s) 402, designed to execute on the guest operating system. The VMM 430 presents the guest operating systems with a virtual operating platform and manages the execution of the guest operating systems.

In some instances, the VMM 430 may allow a guest operating system to run as if it is running on the bare hardware of a system directly. In these instances, the same version of the guest operating system configured to execute on the bare hardware directly may also execute on VMM 430 without modification or reconfiguration. In other words, VMM 430 may provide full hardware and CPU virtualization to a guest operating system in some instances.

In other instances, a guest operating system may be specially designed or configured to execute on VMM 430 for efficiency. In these instances, the guest operating system is “aware” that it executes on a virtual machine monitor. In other words, VMM 430 may provide para-virtualization to a guest operating system in some instances.

The above-described basic computer hardware and software is presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

What is claimed is:

1. A method comprising:
concurrently displaying, on a display device of a computing device, a graphical display and a list display;
wherein the graphical display includes a plurality of entity representations;
wherein each entity representation of the plurality of entity representations represents a corresponding entity of a plurality of entities managed by a computing system;
wherein the list display includes a plurality of item entries;
wherein each item entry of the plurality of item entries represents a corresponding item of a plurality of items;
wherein each item of the plurality of items has a first relationship with one or more of the plurality of entities;
wherein at least one item of the plurality of items has the first relationship with more than one of the plurality of entities;
receiving, at the computing device, first user input that selects a particular item entry in the list display;
responsive to the first user input, automatically highlighting a particular set of entity representations in the graphical display;
wherein the particular set of entity representations is a set of entity representations that correspond to one or more entities that have the first relationship with the item that corresponds to the particular item entry;
receiving, at the computing device, second user input that selects a particular entity representation in the graphical display;
responsive to the second user input, automatically highlighting a particular set of item entries in the list display;
wherein the particular set of item entries is a set of item entries that correspond to one or more items that have the first relationship with the entity that corresponds to the particular entity representation.

2. The method of claim 1 wherein:
each entity of the plurality of entities is a node in a multi-node computer system; and
each item of the plurality of items is a protection group.

3. The method of claim 1 wherein:
each entity of the plurality of entities is a node in a multi-node computer system; and
each item of the plurality of items is a recovery plan.

4. The method of claim 1 wherein:
each entity of the plurality of entities is a node in a multi-node computer system; and
each item of the plurality of items is a virtual machine snapshot.

5. The method of claim 1 wherein:
each entity of the plurality of entities is a node in a multi-node computer system; and
each item of the plurality of items is a data node.

6. The method of claim 1 wherein:
highlighting the particular set of entity representations involves highlighting the particular set of entity representations in a first way;
each item of the plurality of items has a second relationship with zero or more of the plurality of nodes;
wherein the second relationship is a different type of relationship than the first relationship.

7. The method of claim 6, further comprises:
responsive to the first user input, automatically highlighting a second set of entity representations in the graphical display in a second way;
wherein the second way is different than the first way;
the second set of entity representations is a set of entity representations that correspond to the one or more entities that have the second relationship with the item that corresponds to the particular item entry.

8. A system comprising:
a processor,
a communication interface, and
one or more non-transitory computer-readable storage media storing sequences of instructions, which when executed by the processor, cause the processor to:
concurrently display, on a display device of a computing device, a graphical display and a list display;
wherein the graphical display includes a plurality of entity representations;
wherein each entity representation of the plurality of entity representations represents a corresponding entity of a plurality of entities managed by a computing system;
wherein the list display includes a plurality of item entries;
wherein each item entry of the plurality of item entries represents a corresponding item of a plurality of items;
wherein each item of the plurality of items has a first relationship with one or more of the plurality of entities;
wherein at least one item of the plurality of items has the first relationship with more than one of the plurality of entities;
receive, at the computing device, first user input that selects a particular item entry in the list display;
responsive to the first user input, automatically highlight a particular set of entity representations in the graphical display;
wherein the particular set of entity representations is a set of entity representations that correspond to one or more entities that have the first relationship with the item that corresponds to the particular item entry;
receive, at the computing device, second user input that selects a particular entity representation in the graphical display;
responsive to the second user input, automatically highlight a particular set of item entries in the list display;
wherein the particular set of item entries is a set of item entries that correspond to one or more items that have the first relationship with the entity that corresponds to the particular entity representation.

9. The system of claim 8 wherein:
each entity of the plurality of entities is a node in a multi-node computer system; and
each item of the plurality of items is a protection group.

10. The system of claim 8 wherein:
each entity of the plurality of entities is a node in a multi-node computer system; and
each item of the plurality of items is a recovery plan.

11. The system of claim 8 wherein:
each entity of the plurality of entities is a node in a multi-node computer system; and
each item of the plurality of items is a virtual machine snapshot.

12. The system of claim 8 wherein:
each entity of the plurality of entities is a node in a multi-node computer system; and
each item of the plurality of items is a data node.

13. The system of claim 8 wherein:
highlighting the particular set of entity representations involves highlighting the particular set of entity representations in a first way;
each item of the plurality of items has a second relationship with zero or more of the plurality of nodes;
wherein the second relationship is a different type of relationship than the first relationship.

14. The system of claim 13, further comprising sequences of instructions, which when executed by the processor, cause the processor to:
responsive to the first user input, automatically highlight a second set of entity representations in the graphical display in a second way;
wherein the second way is different than the first way;
wherein the second set of entity representations is a set of entity representations that correspond to the one or more entities that have the second relationship with the item that corresponds to the particular item entry.

15. One or more non-transient computer readable storage media comprising instructions which, when executed by a processor, cause the processor to:
concurrently display, on a display device of a computing device, a graphical display and a list display;
wherein the graphical display includes a plurality of entity representations;
wherein each entity representation of the plurality of entity representations represents a corresponding entity of a plurality of entities managed by a computing system;
wherein the list display includes a plurality of item entries;
wherein each item entry of the plurality of item entries represents a corresponding item of a plurality of items;
wherein each item of the plurality of items has a first relationship with one or more of the plurality of entities;
wherein at least one item of the plurality of items has the first relationship with more than one of the plurality of entities;
receive, at the computing device, first user input that selects a particular item entry in the list display;
responsive to the first user input, automatically highlight a particular set of entity representations in the graphical display;
wherein the particular set of entity representations is a set of entity representations that correspond to one or more entities that have the first relationship with the item that corresponds to the particular item entry;
receive, at the computing device, second user input that selects a particular entity representation in the graphical display;
responsive to the second user input, automatically highlight a particular set of item entries in the list display;
wherein the particular set of item entries is a set of item entries that correspond to one or more items that have the first relationship with the entity that corresponds to the particular entity representation.

16. The one or more non-transient computer readable storage media of claim 15 wherein:
each entity of the plurality of entities is a node in a multi-node computer system; and
each item of the plurality of items is a protection group.

17. The one or more non-transient computer readable storage media of claim 15 wherein:
each entity of the plurality of entities is a node in a multi-node computer system; and
each item of the plurality of items is a recovery plan.

18. The one or more non-transient computer readable storage media of claim 15 wherein:
each entity of the plurality of entities is a node in a multi-node computer system; and
each item of the plurality of items is a virtual machine snapshot.

19. The one or more non-transient computer readable storage media of claim 15 wherein:
each entity of the plurality of entities is a node in a multi-node computer system; and
each item of the plurality of items is a data node.

20. The one or more non-transient computer readable storage media of claim 15 wherein:
highlighting the particular set of entity representations involves highlighting the particular set of entity representations in a first way;
each item of the plurality of items has a second relationship with zero or more of the plurality of nodes;
wherein the second relationship is a different type of relationship than the first relationship.
